(19) United States
(12) Patent Application Publication
(10) Pub. No.: US 2021/0269367 A1
(43) Pub. Date: Sep. 2, 2021

(54) FILAMENT WOUND HIGH DENIER ALUMINUM OXIDE FIBER COMPONENTS AND METHODS OF MAKING

(71) Applicant: General Electric Company, Schenectady, NY (US)

(72) Inventors: Johnny Ray Gentry, Bellbrook, OH (US); Jeffrey Robert Josken, Dayton, OH (US); Paul Matthew Payer, Demossville, KY (US)

(21) Appl. No.: 16/804,703

(22) Filed: Feb. 28, 2020

(51) Int. Cl. C04B 35/80

(52) U.S. Cl. CPC C04B 35/803; C04B 35/62236; C04B 2235/96

(57) ABSTRACT

An Oxide-Oxide (Ox-Ox) ceramic matrix composite (CMC) component includes a woven high denier ceramic fiber, the fiber comprising a plurality of tows, the woven fiber having interstitial spacing and the tows comprising the fiber having interstitial spacing, an aluminosilicate matrix, wherein the aluminosilicate matrix occupies the interstitial spacing between the fibers, and wherein the aluminosilicate matrix further occupies at least some of the interstitial spacing between the tows of the fiber. In another aspect, a method of fabricating an Oxide-Oxide (Ox-Ox) component includes the steps of providing a ceramic fiber, providing an aluminosilicate slurry, coating the fiber with the aluminosilicate slurry, filament winding the coated fiber over tooling, forming an uncured preform, removing the uncured Ox-Ox preform from the tooling, and curing the Ox-Ox preform, forming a near net shape Ox-Ox component.

### STATEMENT REGARDING FEDERALLY SPONSORED RESEARCH AND DEVELOPMENT

This invention was made with United States Government support through the Air Force Research Laboratory (AFRL). The United States Government may have certain rights in this invention.

### FIELD OF THE INVENTION

This invention is directed to a method of forming a ceramic matrix composite component, and more specifically to a method of forming a ceramic matrix composite component with high denier fabric component and related equipment.

### BACKGROUND OF THE INVENTION

Ceramic matrix composite (CMC) structures are currently fabricated by a multistep process that utilizes low denier material. Denier is a measurement of fabric mass in grams/900 meters (gm/9000 m), and low denier material is generally more expensive than high denier material. Generally, as used herein, denier is described with respect to a tow comprised of a plurality of fibers, and a higher denier fiber tow may have a greater number of fibers, or fibers of larger size, either or both of which would result in a higher denier measurement than a tow of a smaller number of fibers, or fibers of smaller size. Generally, filaments used in a high denier material are larger and more efficient in terms of throughput to form into fabric than low denier materials.

Of particular interest is the processing of Oxide-Oxide (Ox-Ox) ceramic matrix composites comprising ceramic fibers in an oxide-based matrix which may be utilized in the fabrication of components for aerospace structures. These materials are strong and maintain their strength at high temperatures, making them particularly useful for fabrication of structures exposed to elevated temperatures, such as components of a gas turbine engine used to propel aerospace structures such as aircraft.

FIG. 1 sets forth an exemplary prior art process 10 for fabrication of a component for a gas turbine engine from Ox-Ox CMC materials. A low denier ceramic fiber is provided in step (a) and is then woven in step (b). Weaving involves intertwining the fibers in multiple directions, providing the woven fabric with strength in multiple directions. A slurry bath is also prepared in parallel so that the slurry bath is available concurrently with the woven fabric. The slurry raw materials, provided in step (c), are mixed together to form an aluminosilicate prepreg slurry matrix material in step (d). The woven fabric is then infiltrated with the aluminosilicate slurry material by any convenient method in step (e). One method of infiltrating woven fabric with an aluminosilicate slurry involves spraying the woven fabric with aluminosilicate slurry. Another method draws the woven fabric through an aluminosilicate slurry bath. Any method that infiltrates slurry liquid between the interstices between the woven fabric fibers may be used.

After the woven fabric has been infiltrated with slurry, the slurry is allowed to partially dry, adhering itself to the fibers and forming a tacky prepreg fabric. Some slight solvent content is maintained at this stage. After the prepreg fabric has been formed, it is cut to size to form prepreg plies in step (f) of FIG. 1. The size of the prepreg plies are related to the size and configuration of the component that is to be formed from the Ox-Ox prepreg. The prepreg plies are then laid up to form an uncured component in step (g). In FIG. 1 step (g), the prepreg plies are depicted as being laid up and laminated over a tool that provides the component geometry. The geometry may be complex, but step (g) of FIG. 1 provides a simple geometry for illustration purposes only. The laid up plies are laminated in step (g). The plies may be allowed to dry on the tool or the tool may be heated to speed drying and even partially cure the laid-up plies forming a substantially uncured Ox-Ox component having near net size or even final size, referred to at this stage of the processing as a preform. After the preform has been removed from the tooling or template in step (g) of FIG. 1, it is moved into an autoclave, step (h), where it is cured at elevated temperature. Cure tooling may be utilized to form the preform into a final desired component shape or form. On removal from the autoclave, the cured Ox-Ox component can be further processed. It can be fired at an elevated temperature, then machined or otherwise trimmed to final shape.

As will be appreciated by those skilled in the art, not only is the low denier fiber expensive and subject to breakage in any of the processing steps outlined above, but there are a number of time consuming manufacturing steps involved in forming an Ox-Ox component from low denier fabric. Each step adds further cost to the already expensive low denier fabric.

What is needed is a processing method that is less complex, involves fewer steps, and which allows the use of less expensive material. Ideally, the processing method utilizes less expensive high denier ceramic fiber material for forming an Ox-Ox component and involves fewer manufacturing steps while still producing an Ox-Ox component with high denier fabric but which has the same material properties as does an identical component fabricated by the prior art process with low-denier material.

### BRIEF DESCRIPTION OF THE INVENTION

In one aspect, an Oxide-Oxide (Ox-Ox) ceramic matrix composite (CMC) component includes a woven high denier ceramic fiber, the fiber comprising a plurality of tows, the woven fiber having interstitial spacing and the tows comprising the fiber having interstitial spacing, an aluminosilicate matrix, wherein the aluminosilicate matrix occupies the interstitial spacing between the fibers, and wherein the aluminosilicate matrix further occupies at least some of the interstitial spacing between the tows of the fiber.

In another aspect, a method of fabricating an Oxide-Oxide (Ox-Ox) component includes the steps of providing a ceramic fiber, providing an aluminosilicate slurry, coating the fiber with the aluminosilicate slurry, filament winding the coated fiber over tooling, forming an uncured preform, removing the uncured Ox-Ox preform from the tooling, and curing the Ox-Ox preform, forming a near net shape Ox-Ox component.

In a further aspect, a roller system for impregnating a fiber with a slurry includes a plurality of rollers, the plurality of rollers further including a first roller contacting the fiber and spreading the fiber apart from adjacent fibers, increasing spacing between fibers forming tows before application of slurry to the fiber, at least one intermediate roller contacting the fiber and further increasing the spacing between fibers as resin application to the fiber continues, and a final roller pair comprising opposed, counter-rotating rollers, the fiber passing between the counter-rotating rollers before exiting the roller system, a slurry application system, the slurry application system applying slurry to the fiber after the fiber has been spread apart, an adjustment mechanism, the adjustment mechanism controlling the distance between the counter-rotating rollers so that the impregnated fiber has a predetermined ratio of slurry to fiber, and a fiber tensioning system, the fiber tensioning system sensing fiber tension in the roller system and adjusting the tension of the fiber so that the fiber is not overstressed, thereby preventing fiber breakage during its dwell in the roller system.

In yet another aspect, a tooling system for fabricating an Ox-Ox component includes a supply of fiber, a prepreg slurry mixing system for impregnating fiber with slurry, a tooling drum for receiving impregnated fiber, a first guide for guiding the supply of fiber into the prepreg slurry system, and a second guide for guiding the impregnated fiber onto the tooling drum.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is an exemplary flow chart depicting exemplary prior art processing steps used to prepare prepreg material and fabricate a ceramic matrix component.

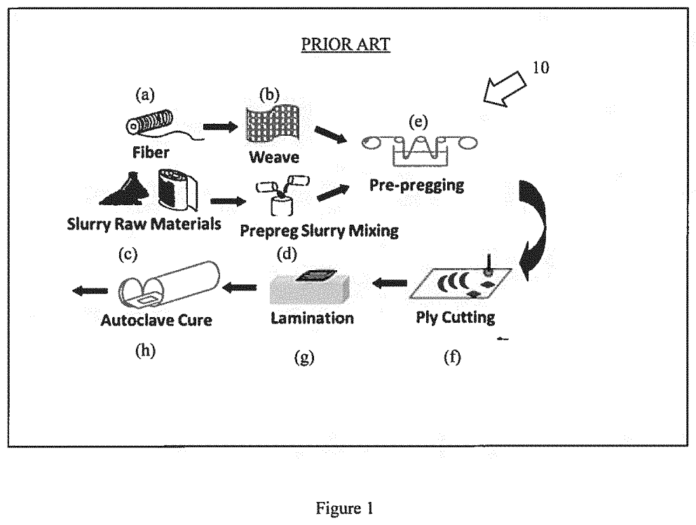

FIG. 2 is an exemplary flow chart illustrating the processing steps of the method described herein used to prepare prepreg material utilizing a high denier fiber and fabricate a ceramic matrix composite component utilizing the ceramic matrix composite prepreg having high denier fiber.

FIG. 3 is a top plan view of an exemplary roller system utilized to impregnate high denier fiber as described herein.

FIG. 4 is an elevational schematic view of the exemplary roller system of FIG. 3.

FIG. 5 is a perspective view depicting an exemplary winding step of the high denier fiber ceramic matrix composite onto an exemplary tooling system as described herein.

FIG. 6 is a perspective view depicting an exemplary densification and curing tool system which may be used for curing the uncured fiber ceramic matrix composite from FIG. 5 after removal from the wind tooling system.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

The terms “coupled”, “fixed”, “attached to”, and the like refer to direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various aspects of the invention are explained more fully with reference to the exemplary embodiments discussed below. It should be understood that, in general, the features of one embodiment also may be used in combination with features of another embodiment, and that the embodiments are not intended to limit the scope of the invention.

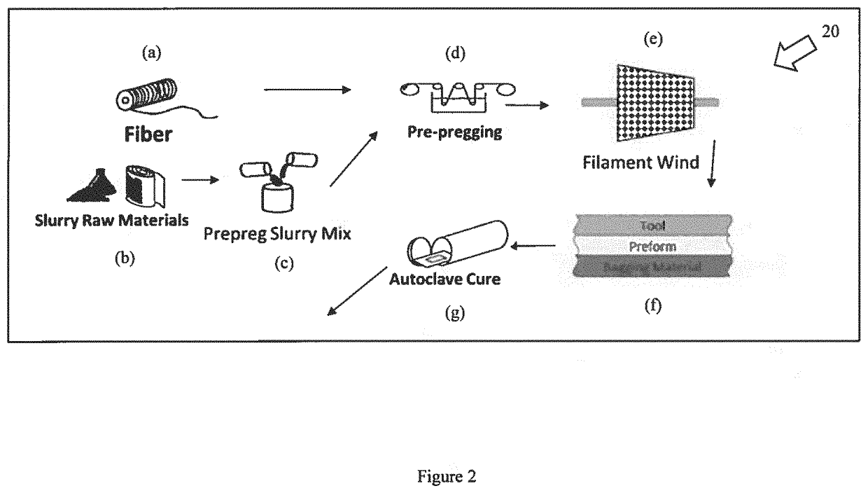

FIG. 2 is an exemplary flow chart illustrating the processing steps of the exemplary method 20 described herein used to prepare prepreg material utilizing a high denier fiber and fabricate a ceramic matrix composite component, such as a CMC gas turbine engine component, utilizing the ceramic matrix composite prepreg having high denier fiber. A high denier ceramic fiber, such as greater than about 3000, greater than about 4500, or greater than about 10,000, is provided in step (a). A slurry bath is also prepared in parallel so that the slurry bath is available concurrently with the high denier ceramic fiber. The slurry raw materials, provided in step (b), are mixed together to form an aluminosilicate prepreg slurry matrix material in step (c). The high denier ceramic fibers are then coated with the aluminosilicate slurry material in step (d) and wound onto a suitably-sized and shaped tooling system to form an uncured component in step (e).

In FIG. 2 step (e), the prepreg plies are depicted as being laid up and laminated over a tool that provides the component geometry. The geometry may be complex, but step (e) of FIG. 2 provides a simple geometry for illustration purposes only. The plies may be allowed to partially dry on the tool or the tool may be heated to speed drying forming a substantially uncured Ox-Ox component having near net size or even final size, referred to at this stage of the processing as a preform. A low solvent content is desirable for tack but normally some solvent remains at this stage. After the preform has been removed from the tooling or template in step (e) of FIG. 2, it is placed into a suitably-sized and -shaped curing tool and a vacuum bag is applied as in step (f). The preform, tool, and vacuum bag combination is then moved into an autoclave, step (g), where it is cured at elevated temperature. On removal from the autoclave, the cured Ox-Ox component can be further processed. It can be fired at an elevated temperature, then machined or otherwise trimmed to final shape.

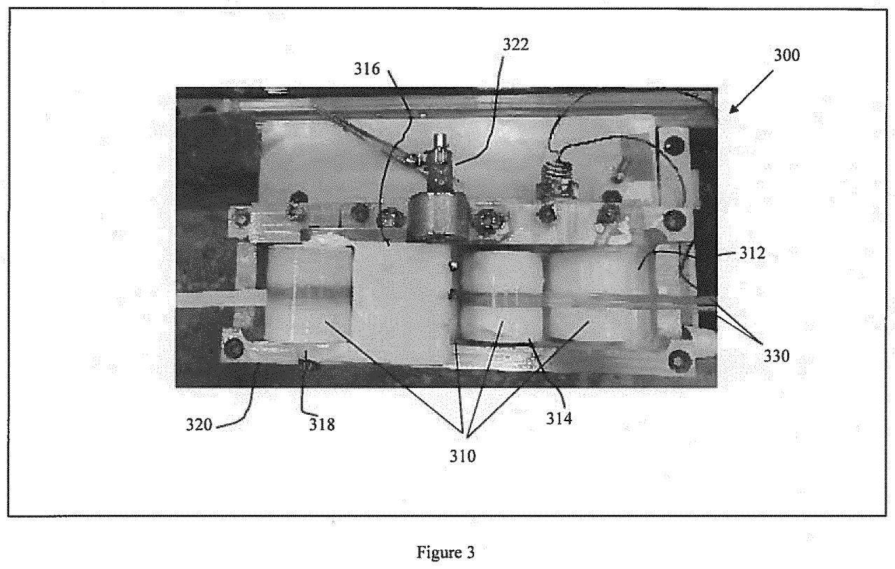

FIG. 3 is a top plan view of an exemplary roller system which may be utilized to impregnate the high denier fibers as described herein. The roller system properly conditions the high denier fiber so that it can be impregnated with ceramic slurry. High denier fiber, such as NEXTEL® 720 available from the 3M Company of Minneapolis, Minn., is supplied by the manufacturer with a coating of sizing. The sizing is applied to facilitate handling of the fiber. Without the sizing, the fiber is very brittle and is easy to break if not handled with extreme care. However, the sizing also adversely affects the interfacial properties of the final composite (it is burned off in the final sintering operation, leaving a “disband” between fiber and matrix).

Before impregnating the high denier fiber, it is first necessary to remove the sizing. Once the sizing is removed, the high denier fiber must be impregnated with ceramic slurry without breaking the material. The roller system 300 depicted in FIG. 3 enables the impregnation of the high denier fiber while minimizing the likelihood of fiber breakage during the impregnation process. The roller system 300 of FIG. 3 includes a plurality of rollers 310 aligned in a serial arrangement. The roller system is positioned over, or partly immersed in, a ceramic slurry. In FIG. 3, a series of four rollers 312, 314, 316, 318, is depicted. More or fewer rollers may be included in the roller system, as will become apparent to one skilled in the art.

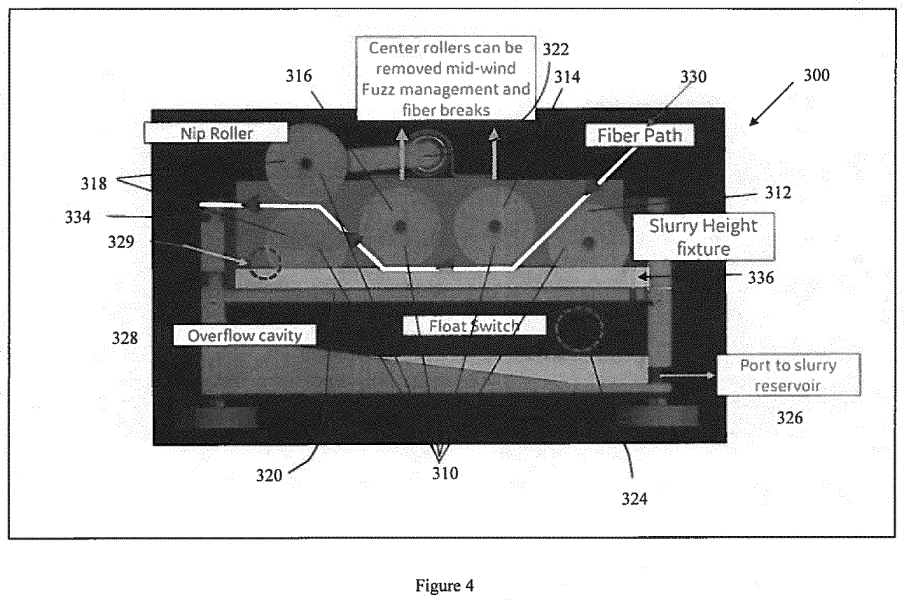

The roller system 300 includes a container 320 that contains the ceramic slurry, which may be a solution of ceramic material in a solvent or a suspension of ceramic particles in a liquid. The roller system may sit over or reside within container 320. Ceramic slurry may be metered into container 320 to maintain the slurry at a minimum level so that a continuous fiber impregnation operation is maintained. Preferably, the slurry is maintained at a constant level within container 320. The roller system also includes an adjustment system 322 to adjust the distance between the last pair of rollers 318, which controls the amount of ceramic slurry on the Impregnated fiber as it exits roller system 300. Any method of applying some force to the top and/or bottom rollers 318 may be utilized, including a spring, electronic load cell, etc. In the exemplary embodiment of FIGS. 3 and 4, a spring is utilized in the adjustment system 322 to exert a force on the top roller toward the bottom roller of the pair of rollers 318.

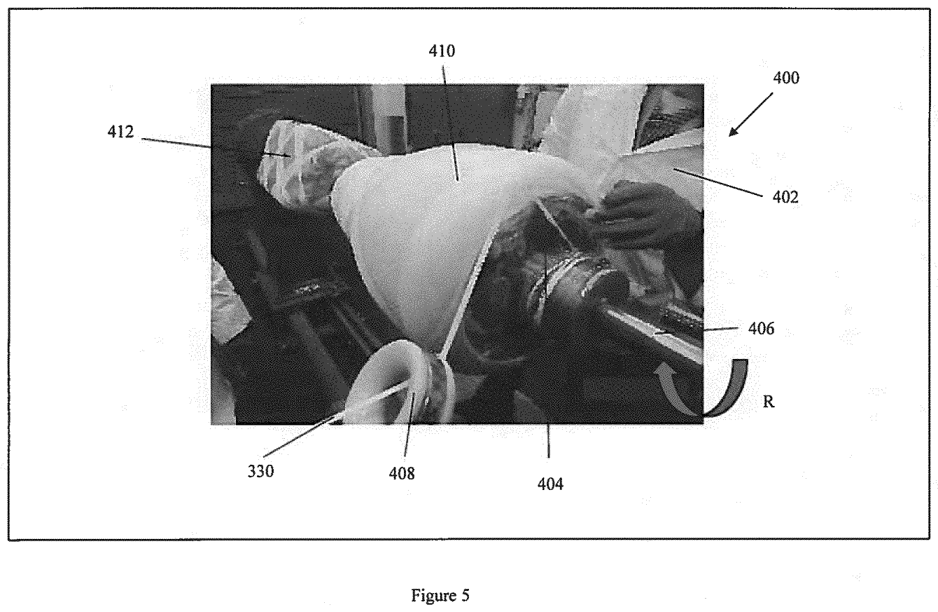

De-sized fiber 330 enters the roller system 300 and passes over roller 312. Since the de-sized fiber is extremely brittle and readily subject to failure, a fiber tensioning system (not shown) at the input end of roller system 300 maintains the tension of the fiber 330, such tensioning systems being well known in the art. The tensioning system is generally before the slurry bath, to create tension in the bath over the rollers. Tension is also needed for proper placement of the fiber 330 on the mandrel, downstream of the roller system 300. Fiber is tensioned between the tensioning system and the mandrel or tool (shown in FIG. 5), which pulls the fiber through the roller system 300. In the embodiment of FIG. 3, the incoming fiber 330 is in the form of one or more fiber tows which are bands or bundles of individual fibers. The fiber 330 passes over the roller 312 and down into the ceramic slurry. The roller 312 spreads the fiber, flattening the fiber from a substantially circular cross-section into flatter cross-section. This operation spreads the fiber, increasing the spacing of the fibers in tows and facilitating penetration of the ceramic slurry between the adjacent fibers of the tows. Spreading fibers of tows, and thus increasing spacing between adjacent fibers, makes impregnation efficient and increases tow bandwidth which is an important characteristic in making a well-consolidated filament wound composite preform.

After passing over roller 312, the fiber 330 is submerged into the ceramic slurry. Each roller, 312, 314, 316, and 318 increases the spread of the fiber 330 to further facilitate penetration of the ceramic slurry into the fiber. After passing over roller 312, the fiber passes under roller 314 and roller 316, remaining immersed in the ceramic slurry. As will be understood by those skilled in the art, rollers may be added or removed to increase or decrease the spread of the fiber and dwell time in the ceramic slurry, and a variety of fiber pathways can be utilized. Center rollers 314 and 316 may be removed if necessary mid-wind (in the middle of a wind) for fuzz management (removal of fuzz buildup) and to remedy any fiber breaks.

The last roller 318 actually includes one nip roller (the upper, spring-biased roller in FIGS. 3 and 4) and one exit roller (the lower roller in FIGS. 3 and 4) forming a pair of counter-rotating rollers, the fiber passing around roller 316 and between the counter-rotating rollers 318. The roller system 300 also includes a spring adjustment mechanism 322. The spring adjustment feature 322 controls the spacing and/or force between the pair of counter-rotating rollers 318. The force exerted by rollers 318 upon the fiber 330 in turn determines the amount of ceramic slurry that is incorporated into the fiber 330. A higher spacing provides an impregnated fiber with a higher ceramic slurry content, while reduced spacing reduces the ceramic slurry content in the impregnated fiber. An exemplary ratio of fiber/matrix content in an impregnated fiber is between about 60/40 to about 40-60 by weight; that is, the fiber weight of an impregnated fiber varies between about 40-60% by weight and the ceramic matrix content varies between about 40-60% by weight. An uncoated fiber is about 100% fiber by weight percent. One exemplary ratio of fiber/matrix content is about 50/50 by weight; that is, each unit weight of impregnated fiber includes about 50% by weight of fiber and about 50% by weight ceramic matrix and the spacing between counter-rotating rollers 318 is maintained to provide such a ratio. Ratios and percentages described herein with respect to fiber/matrix content are intended to refer to a final weight after solvents present in the slurry is evaporated, thus also referred to as a dry resin content. As the impregnated fiber passes between counter-rotating rollers 318, excess ceramic slurry is gently squeezed from the fiber and returned to container 320.

FIG. 4 is an elevational schematic view of the exemplary roller system of FIG. 3, illustrating with greater clarity some aspects which were not as visible in the plan view of FIG. 3. In addition to the elements shown in FIG. 3, in FIG. 4 the roller system 300 may include an upper chamber or container 320 which receives slurry from an inlet 334 and maintains the slurry at a suitable height 329 using a slurry height control fixture 336, illustrated here as a dam, with excess slurry flowing to an overflow cavity 328 which is monitored by a float switch 324, which can activate a pump (not shown) to pump excess slurry through a port 326 to a slurry reservoir (not shown). Slurry height control fixture 336 may also include a sensor for controlling the flow of slurry through inlet 334.

FIG. 5 is a perspective view depicting an exemplary winding step of the high denier fiber ceramic matrix composite tow 330 onto an exemplary tooling system 400 as described herein. In the embodiment of FIG. 5, an operator 402 is monitoring the winding of the impregnated fiber tow 330 onto a tooling system 400 which takes the form of a mandrel 404. Mandrel 404, in this embodiment, is a male pattern item forming a shape of revolution upon which the fiber tow 330 is wound and is rotated by a shaft 406 which may be driven a rotation direction indicated by arrow R by a motor, gearbox, or other drive system identified by numeral 412. The drive system 412 and a payoff eyelet 408 are operated in concert by a control system to guide the fiber tow 330 onto the mandrel 404 in the desired final wind pattern of the preform 410. Characteristics of the wind pattern may include spacing of the windings and angle of the windings with respect to the axis of the mandrel 404 which, as depicted, may coincide with the axis of the shaft 406. Mandrel 404 may be collapsible or otherwise configured to facilitate the removal of the preform 410 when the winding step is completed. The winding operation continues until the preform 410 has the desired number of windings and/or reaches the desired thickness.

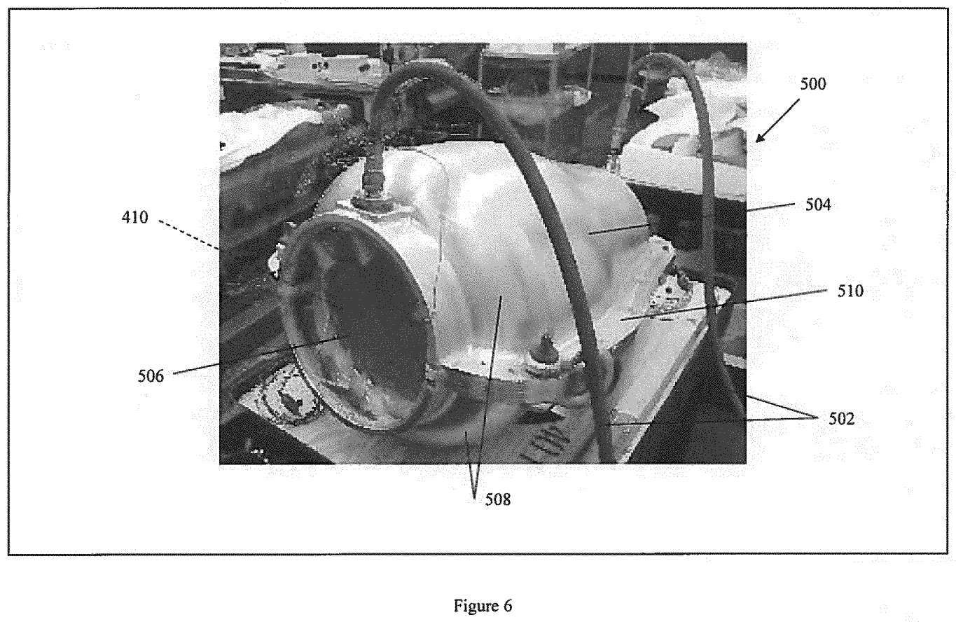

FIG. 6 is a perspective view depicting an exemplary densification and curing tooling system which may be used for curing the uncured fiber ceramic matrix composite preform 410 from FIG. 5 after removal from the tooling system 400. In some embodiments, the mandrel 404 may comprise or be part of the curing tool. However, in the embodiment of FIG. 6, the curing tool 504 takes the form of a cylindrical shell mold 508 which is formed in two halves and joined by mating flanges 510 to facilitate insertion of the preform 410. The curing tool 504 includes vacuum lines 502 to aid in debulking the preform. A bagging material 506 is applied over top of the preform 410 and sealed to the curing tool 504 to form a 3-layer sandwich structure of curing tool 504, preform 410, and bagging material 506 as depicted in step (t) of FIG. 2. Although in the embodiment of FIG. 6 the curing tool 504 is illustrated as a hollow female shell into which the preform is inserted to form a desired external shape of a final component, it is envisioned that in some embodiments a male curing tool may be utilized to form a desired internal shape of a final component with the preform 401 applied to the exterior surface of the male curing tool and a bagging material 506 applied externally.

Once the preform 410 is associated with the curing tool 504, bagging material 506, and vacuum sources 502, the curing tool 504 is then placed into an autoclave at desired temperature and vacuum conditions for a desired amount of time to debulk and fully cure the preform into a finished component. The finished component may be coated, machined, or otherwise operated upon as desired.

Without wishing to be bound by theory, it is believed that better properties of a CMC component are obtained when a wider tow or band of fibers is used having a width to thickness ratio of greater than about 20:1 for winding onto a mandrel. Such a width to thickness ratio reduces the porosity and matrix regions between overlaps of the tow. Similarly, a larger wind pattern reduces the number of overlaps.

The system and methods described herein also reduce fuzz levels inherent with un-sized Nextel fibers, particularly with roller diameters greater than about 1 inch and with a compliant surface.

The system and methods described herein also enable wind patterns producing unit cells (the distance between consecutive tow passes on the same layer) of greater than about 1.8 inches, which have been demonstrated to provide mechanical property equivalence to prior art systems and methods. Dimensions may vary along the axial length of a non-cylindrical mandrel, with larger unit cells where mandrel diameter is larger.

Unless defined otherwise, all technical and scientific terms used herein have the same meaning as commonly understood by one of ordinary skill in the art to which the invention pertains. Although a number of methods and materials similar or equivalent to those described herein can be used in the practice of the invention, materials and methods according to some embodiments are described herein.

As will be appreciated by one having ordinary skill in the art, the methods and systems of the invention substantially reduce or eliminate the disadvantages and drawbacks associated with prior art methods and systems.

It should be noted that, when employed in the present disclosure, the terms “comprises”, “comprising”, and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Various characteristics, aspects, and advantages of the present disclosure may also be embodied in any permutation of aspects of the disclosure, including but not limited to the following technical solutions as defined in the following enumerated aspects of the invention.

1. An Oxide-Oxide (Ox-Ox) ceramic matrix composite (CMC) component includes a woven high denier ceramic fiber, the fiber comprising a plurality of tows, the woven fiber having interstitial spacing and the tows comprising the fiber having interstitial spacing, an aluminosilicate matrix, wherein the aluminosilicate matrix occupies the interstitial spacing between the fibers, and wherein the aluminosilicate matrix further occupies at least some of the interstitial spacing between the tows of the fiber.

2. The Ox-Ox CMC component of aspect 1, wherein the fiber has a denier of at least about 3000.

3. The Ox-Ox CMC component of aspects 1 or 2, wherein the fiber has a denier of about 10,000.

4. The Ox-Ox CMC component of aspects 1-3, wherein the fiber is selected from the group consisting of Nextel® 610 and Nextel® 720.

5. The Ox-Ox CMC component of aspects 1-4, wherein the fiber is impregnated with aluminosilicate matrix material and has a weight ratio of fiber to aluminosilicate matrix material between about 40% fiber to 60% matrix material and between about 60% fiber to 40% matrix material.

6. The Ox-OX CMC component of aspects 1-5, wherein the fiber is impregnated with aluminosilicate matrix material and has a weight ratio of fiber to aluminosilicate matrix material of about 50% fiber to 50% matrix material.

7. A method of fabricating an Oxide-Oxide (Ox-Ox) component includes the steps of providing a ceramic fiber, providing an aluminosilicate slurry, coating the fiber with the aluminosilicate slurry, filament winding the coated fiber over tooling, forming an uncured preform, removing the uncured Ox-Ox preform from the tooling, and curing the Ox-Ox preform, forming a near net shape Ox-Ox component.

8. The method of aspect 7, wherein the step of providing ceramic fiber includes providing high denier ceramic fiber.

9. The method of aspects 7 or 8, wherein the step of providing high denier ceramic fiber includes providing fiber having at least about 3000 denier.

10. The method of aspects 7-9, wherein the step of providing high denier ceramic fiber includes providing fiber having about 10,000 denier.

11. The method of aspect 10, wherein the step of providing ceramic fiber having a mass of 10,000 denier includes providing a ceramic fiber selected from the group consisting of Nextel® 720 and Nextel® 610.

12. The method of aspects 7-11, further including a step of desizing the fiber after the step of providing the fiber and before the step of coating the fiber.

13. The method of aspects 7-12, wherein the step of coating the desized fiber further includes tensioning the desized fiber thereby preventing breaking of the fiber.

14. The method of aspects 7-13, wherein the step of filament winding the desized fiber also includes tensioning the desized fiber.

15. The method of aspects 7-14, wherein the step of coating the fiber with aluminosilicate slurry further includes the additional steps of spreading the fiber thereby separating tows comprising the fiber and infiltrating the interstitial spacing between the fibers with aluminosilicate slurry.

16. The method of aspects 7-15, further including the additional step of removing excess aluminosilicate slurry from the fiber after coating the fiber and before filament winding the fiber.

17. The method of aspect 16, wherein the step of removing excess aluminosilicate slurry from the fiber further provides a coated, impregnated fiber having a ratio of fiber/matrix content by weight of between about 60/40 fiber to matrix to about 40/60 fiber to matrix.

18. The method of aspects 16 or 17, wherein the step of removing excess aluminosilicate slurry from the fiber further provides a coated, impregnated fiber having a ratio of fiber/matrix content by weight of about 50/50 fiber to matrix.

19. A roller system for impregnating a fiber with a slurry includes a plurality of rollers, the plurality of rollers further including a first roller contacting the fiber and spreading the fiber apart from adjacent fibers, increasing spacing between fibers forming tows before application of slurry to the fiber, at least one intermediate roller contacting the fiber and further increasing the spacing between fibers as resin application to the fiber continues, and a final roller pair comprising opposed, counter-rotating rollers, the fiber passing between the counter-rotating rollers before exiting the roller system, a slurry application system, the slurry application system applying slurry to the fiber after the fiber has been spread apart, an adjustment mechanism, the adjustment mechanism controlling the distance between the counter-rotating rollers so that the impregnated fiber has a predetermined ratio of slurry to fiber, and a fiber tensioning system, the fiber tensioning system sensing fiber tension in the roller system and adjusting the tension of the fiber so that the fiber is not overstressed, thereby preventing fiber breakage during its dwell in the roller system.

20. The roller system of aspect 19, further including a fiber entry guide for locating the fiber on the first roller, and a fiber exit guide for receiving the fiber after passing through the final roller pair.

21. The roller system of aspects 19 or 20, wherein the slurry application system includes a container positioned below the roller system, the container including slurry into which the fiber is guided after passing over the first roller.

22. The roller system of aspect 21, wherein the slurry application system includes a slurry height control mechanism for maintaining the slurry within the container at a predetermined level.

23. The roller system of aspect 22, further included a valve-controlled conduit in fluid communication with a slurry storage device, the valve-controlled conduit opening to provide slurry to the container when the slurry height control mechanism determines that the slurry in the container is below a predetermined level.

24. In yet another aspect, a tooling system for fabricating an Ox-Ox component includes a supply of fiber, a prepreg slurry mixing system for impregnating fiber with slurry, a tooling drum for receiving impregnated fiber, a first guide for guiding the supply of fiber into the prepreg slurry system, and a second guide for guiding the impregnated fiber onto the tooling drum.

25. The tooling system of aspect 24, further including a desizing system for removing sizing from the fiber prior to impregnating the fiber with slurry.

26. The tooling system of aspects 24 or 25, wherein the tooling drum is a storage cylinder, the second guide guiding the impregnated fiber onto the cylinder for subsequent usage.

27. The tooling system of aspects 24-26, wherein the tooling drum is a mandrel that molds the fiber into a green structure, the second guide guiding the impregnated fiber onto the mandrel prior to subsequent processing of the green structure.

28. The tooling system of aspects 24-27, further including a fiber tensioning system, the fiber tensioning system sensing fiber tension in the tooling system during processing adjusting the tension of the fiber so that the fiber is not overstressed, thereby preventing fiber breakage during processing.

29. The tooling system of claim aspects 24-28, further including a bagging system applying pressure to the green structure on a curing tool.

30. The tooling system of aspects 24-29, further including an autoclave, the autoclave curing the green structure using the curing tool.

While this disclosure has been described as having exemplary embodiments, the present disclosure can be further modified within the spirit and scope of this disclosure. This application is therefore intended to cover any variations, uses, or adaptations of the disclosure using its general principles. Further, this application is Intended to cover such departures from the present disclosure as come within known or customary practice in the art to which this disclosure pertains and which fall within the limits of the appended claims.

1. An Oxide-Oxide (Ox-Ox) ceramic matrix composite (CMC) component, comprising:
a woven high denier ceramic fiber, the fiber being at least 3,000 denier, the fiber comprising no sizing coating, the fiber comprising a plurality of tows, the fiber having interstitial spacing and the plurality of tows comprising the fiber having interstitial spacing;
an aluminosilicate matrix;
wherein the aluminosilicate matrix occupies the interstitial spacing between the fiber, and
wherein the aluminosilicate matrix further occupies at least some of the interstitial spacing between the plurality of tows of the fiber.

2. The Ox-Ox CMC component of claim 1, wherein the component is a gas turbine engine component.

3. The Ox-Ox CMC component of claim 1, wherein the fiber is at least about 10,000 denier.

4. The Ox-Ox CMC component of claim 1, wherein the aluminosilicate matrix is formed from an aluminosilicate slurry.

5. The Ox-Ox CMC component of claim 1, wherein the fiber is impregnated with the aluminosilicate matrix and has a weight ratio of fiber to aluminosilicate matrix between about 40% fiber to 60% matrix and between about 60% fiber to 40% matrix.

6. The Ox-Ox CMC component of claim 1, wherein the fiber is impregnated with aluminosilicate matrix and has a weight ratio of fiber to aluminosilicate matrix material of about 50% fiber to 50% matrix.

7. A method of fabricating an Oxide-Oxide (Ox-Ox) component, comprising the steps of:
providing a ceramic fiber;
providing an aluminosilicate slurry;
coating the fiber with the aluminosilicate slurry;
filament winding the coated fiber over tooling, forming an uncured preform;
removing the uncured Ox-Ox preform from the tooling;
curing the Ox-Ox preform, forming a near net shape Ox-Ox component.

8. The method of claim 7, wherein the step of providing ceramic fiber includes providing high denier ceramic fiber.

9. The method of claim 8, wherein the step of providing high denier ceramic fiber includes providing fiber having at least about 3000 denier.

10. The method of claim 9, wherein the step of providing high denier ceramic fiber includes providing fiber having about 10,000 denier.

11. The method of claim 10, wherein the step of providing ceramic fiber having a mass of 10,000 denier includes providing a ceramic fiber selected from the group consisting of Nextel® 720 and Nextel® 610.

12. The method of claim 7, further including a step of desizing the fiber after the step of providing the fiber and before the step of coating the fiber.

13. The method of claim 12, wherein the step of coating the desized fiber further includes tensioning the desized fiber thereby preventing breaking of the fiber.

14. The method of claim 12, wherein the step of filament winding the desized fiber also includes tensioning the desized fiber.

15. The method of claim 7, wherein the step of coating the fiber with aluminosilicate slurry further includes the additional steps of
spreading the fiber thereby separating tows comprising the fiber; and
infiltrating the interstitial spacing between the fibers with aluminosilicate slurry.

16. The method of claim 7, further including the additional step of removing excess aluminosilicate slurry from the fiber after coating the fiber and before filament winding the fiber.

17. The method of claim 16, wherein the step of removing excess aluminosilicate slurry from the fiber further provides a coated, impregnated fiber having a ratio of fiber/matrix content by weight of between about 60/40 fiber to matrix to about 40/60 fiber to matrix.

18. The method of claim 17, wherein the step of removing excess aluminosilicate slurry from the fiber further provides a coated, impregnated fiber having a ratio of fiber/matrix content by weight of about 50/50 fiber to matrix.

19. A roller system for impregnating a fiber with a slurry, comprising:
a plurality of rollers, the plurality of rollers further comprising;
a first roller contacting the fiber and spreading the fiber apart from adjacent fibers, increasing spacing between fibers forming tows before application of slurry to the fiber,
at least one intermediate roller contacting the fiber and further increasing the spacing between fibers as resin application to the fiber continues, and
a final roller pair comprising opposed, counter-rotating rollers, the fiber passing between the counter-rotating rollers before exiting the roller system;
a slurry application system, the slurry application system applying slurry to the fiber after the fiber has been spread apart;
an adjustment mechanism, the adjustment mechanism controlling the distance between the counter-rotating rollers so that the impregnated fiber has a predetermined ratio of slurry to fiber; and
a fiber tensioning system, the fiber tensioning system sensing fiber tension in the roller system and adjusting the tension of the fiber so that the fiber is not overstressed, thereby preventing fiber breakage during its dwell in the roller system.

20. The roller system of claim 19, further including a fiber entry guide for locating the fiber on the first roller, and a fiber exit guide for receiving the fiber after passing through the final roller pair.

21. The roller system of claim 19, wherein the slurry application system includes a container positioned below the roller system, the container including slurry into which the fiber is guided after passing over the first roller.

22. The roller system of claim 21, wherein the slurry application system includes a slurry height control mechanism for maintaining the slurry within the container at a predetermined level.

23. The roller system of claim 22, further included a valve-controlled conduit in fluid communication with a slurry storage device, the valve-controlled conduit opening to provide slurry to the container when the slurry height control mechanism determines that the slurry in the container is below a predetermined level.

24. A tooling system for fabricating an Ox-Ox component comprising a supply of fiber;
a prepreg slurry mixing system for impregnating fiber with slurry;
a tooling drum for receiving impregnated fiber;
a first guide for guiding the supply of fiber into the prepreg slurry system; and
a second guide for guiding the impregnated fiber onto the tooling drum.

25. The tooling system of claim 24, further including a desizing system for removing sizing from the fiber prior to impregnating the fiber with slurry.

26. The tooling system of claim 24, wherein the tooling drum is a storage cylinder, the second guide guiding the impregnated fiber onto the cylinder for subsequent usage.

27. The tooling system of claim 24, wherein the tooling drum is a mandrel that molds the fiber into a green structure, the second guide guiding the impregnated fiber onto the mandrel prior to subsequent processing of the green structure.

28. The tooling system of claim 24, further including a fiber tensioning system, the fiber tensioning system sensing fiber tension in the tooling system during processing adjusting the tension of the fiber so that the fiber is not overstressed, thereby preventing fiber breakage during processing.

29. The tooling system of claim 24, further including a bagging system applying pressure to the green structure on a curing tool.

30. The tooling system of claim 24, further including an autoclave, the autoclave curing the green structure using the curing tool.
